(19) United States
(12) Patent Application Publication
(10) Pub. No.: US 2006/0206585 A1
(43) Pub. Date: Sep. 14, 2006

(54) System and method for publishing targeted copy in a previously opened document independent of a user-initiated submission

(75) Inventors: Thomas Lubin, Chicago, IL (US); Eamon Daly, Chicago, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: NextWave Media Group, LLC

(21) Appl. No.: 11/074,377

(22) Filed: Mar. 7, 2005

(51) Int. Cl. H04N 1/00; G06F 15/16

(52) U.S. Cl. 709/219; 358/434; 709/203

(57) ABSTRACT

A system for publishing targeted copy in an electronic originating document already generated on a computer. The originating document has text, at least one data field and a user-initiated submission element. The system includes polling code that is called by a first launch code embedded in the originating document. The polling code polls at least data field found in the originating document until expected data is received by the polling code without actuation of the user-initiated submission element. The system further includes a second launch code that is written into the originating document after the expected data is received by the polling code. This second launch code calls the injector code portion of the system that injects a selected one of the plurality of individually selectable content from a database into the originating document. An associated method is also disclosed.

### BACKGROUND OF THE INVENTION

1. Field of the Invention

The present invention relates in general to document publishing systems and, in particular, to a system and method of serving dynamic content.

2. Background art

Document publishing systems are well known in the art. They are found throughout the Internet and especially as part of the World Wide Web. Most of these document publishing systems require user-initiated actions, such as filling out and submitting search forms, searching through lists of information, or otherwise fetching documents by name, content, or hierarchy. In many cases, however, the process of finding this information distracts from the task at hand, and requires the user to divert attention away from the current document in order to search out other information. More importantly, users fail to submit their input all too frequently. As a result, potentially relevant content is not delivered to the user.

While a current methodology exists which allows modern web browsers to retrieve additional copy from a server after the originating document is served (known as Microsoft.XMLHTTP or Msxm12.XMLHTTP), these functions have been intentionally limited to prevent retrieval of additional content if the content source is not identical to that of the originating document.

Accordingly, there is a need for a system and method that asynchronously retrieves and displays additional information within a previously displayed document without any need for the user to initiate the action through a submit button or other mechanism. A system and method that meets this need would be particularly beneficial in the area of “Internet ad serving.” “Internet ad serving” involves the delivery of advertising content onto web pages. Commonly today, ads are served along side search results on Google™, Yahoo!™ and other search engines with content that is associated with the search terms that were submitted on a search form by the user. This interactivity is prized by advertisers because it delivers a targeted audience more likely to be interested in the goods or services being advertised. However, the advertising typically cannot be targeted for the user until the user submits their search form. In addition, users who fail to submit their search form are a lost opportunity for these targeted advertisements, for which advertisers often pay a premium. Frequently, these ads are served by third-party ad companies. Consequently, there is an associated need to provide a system that can serve additional targeted content to be served by a third-party.

Similarly, the more user information is available to ad serving companies, the better the targeted information that can be provided. Thus, there is an associated desire to provide a method of specifying validation methods that can refine the targeting data used to determine what additional information will be retrieved.

These and other needs may be met by providing a novel method and system for delivering dynamic content on a previously loaded document.

### SUMMARY OF THE INVENTION

A system for publishing targeted copy in an electronic originating document already generated on a computer. The originating document has text, a data region including at least one data field and may also include a user-initiated submission element. The data field may be a user input region, a static copy, or a hidden field. The system includes polling code that is called by a first launch code embedded in the originating document. The polling code polls at least one data field found in the originating document until expected data is received by the polling code without actuation of the user-initiated submission element. The polling code may also be operably associated with code for validating the polled data. The system further includes a second launch code that is written into the originating document after the expected data is received by the polling code. This second launch code calls the injector code portion of the system that injects a selected one of the plurality of individually selectable content from a database into the originating document.

In a preferred approach, the polling code polls the originating document continuously on the order of once every ¼ second. In this manner the injector can deliver the targeted content to the originating document as soon as practical. In this way, the injected content can be available just in time for further data entry or can be displayed before the end user either goes to the next web page or closes the browser without even submitting the data input on the originating document. As such, many needs in the industry are met by the present invention.

The polling and injector codes may be run on a server that is in operable communication with the computer generating the originating document. In some examples, the database may be hosted on a third party computer separate from the computer and the server generating the original document. In such manner, it is possible—although not necessary—for the originating document to have been downloaded from a first domain and the polling and injector codes to be running in a second domain, while the database may be hosted in yet a third domain. Conversely, it is further contemplated that the polling and injector codes along with the database could be hosted in the same domain that originated the originating document.

The system for publishing targeted copy in an electronic originating document may similarly be implemented by means that comprise varying combinations of hardware and software. Still, the system will include means (called by a first launch code) for polling a data field in the originating document; means for writing a second launch code in the originating document after the expected data is received by the polling means; a database containing a plurality of individually selectable content; and means for injecting a selected one of the plurality of individually selectable content from the database into the originating document, the injecting means called by the second launch code.

As such the invention includes a method for publishing targeted copy in an electronic originating document already generated on a computer comprising: (a) writing a first launch code in the originating document; (b) polling the at least one data field when called by the first launch code until expected data is received without a user-initiated submission of the expected data; (c) writing a second launch code in the originating document after the expected data is received; (d) selecting content from a database based on the expected data; and (e) injecting the selected content into the originating document, when called by the second launch code. The method may also include validating the polled data.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIGS. 1A, 1B and 1C of the drawings are block diagrams illustrating a high level architecture of the system at three successive periods of operation.

FIG. 2A of the drawings is an illustration of the appearance of an exemplary embodiment of an electronic originating document as it may appear to an end user on a video monitor associated with a computer prior to the expected data being received by the polling means.

FIG. 2B of the drawings is an illustration of the source code that generated the illustrative electronic originating document of FIG. 2A.

FIG. 2C of the drawings is an illustration of the appearance of the electronic originating document of FIG. 2A as it may appear to an end user on a video monitor associated with a computer after the expected data has been received and the injector means has injected the targeted copy.

FIG. 3A of the drawings is an illustration of the appearance of another exemplary embodiment of an electronic originating document as it may appear to an end user on a video monitor associated with a computer prior to the expected data being received by the polling means.

FIG. 3B of the drawings is an illustration of the appearance of the electronic originating document of FIG. 3A as it may appear to an end user on a video monitor associated with a computer after the expected data has been received and the injector means has injected the targeted copy.

FIG. 4A of the drawings is an illustration of the appearance of yet another exemplary embodiment of an electronic originating document as it may appear to an end user on a video monitor associated with a computer prior to the expected data being received by the polling means.

FIG. 4B of the drawings is an illustration of the appearance of the electronic originating document of FIG. 4A as it may appear to an end user on a video monitor associated with a computer after the expected data has been received and the injector means has injected the targeted copy.

FIG. 5 of the drawings is a flow diagram of a process that serves targeted copy independent of a user-initiated action.

FIG. 6 of the drawings is another flow diagram of a process that serves targeted copy independent of a user-initiated action.

FIG. 7 of the drawings is an illustration of one source code implementation of an exemplary polling means for use in the novel system.

FIG. 8 of the drawings is a block diagram of exemplary computers that may support various portions of the system.

### BEST MODES OF PRACTICING THE INVENTION

While the present invention may be embodied in many different forms, several specific embodiments are discussed herein with the understanding that the present disclosure is to be considered only as an exemplification of the principles of the invention, and it is not intended to limit the invention to the embodiments illustrated.

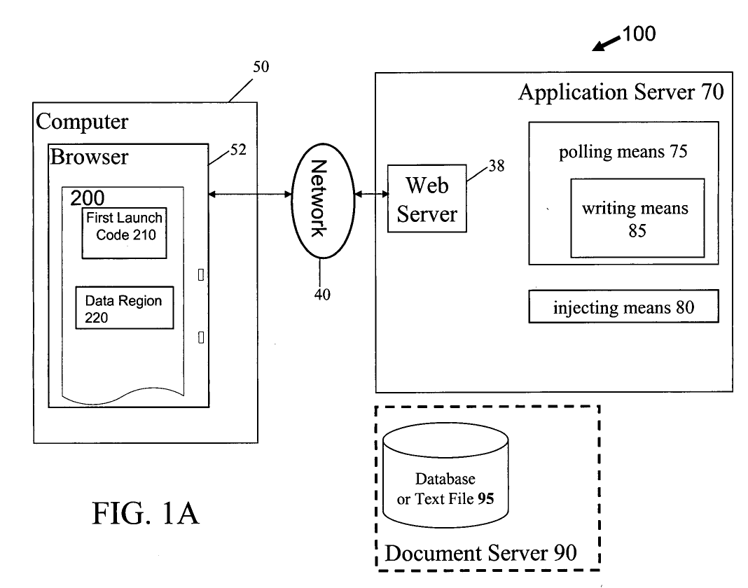

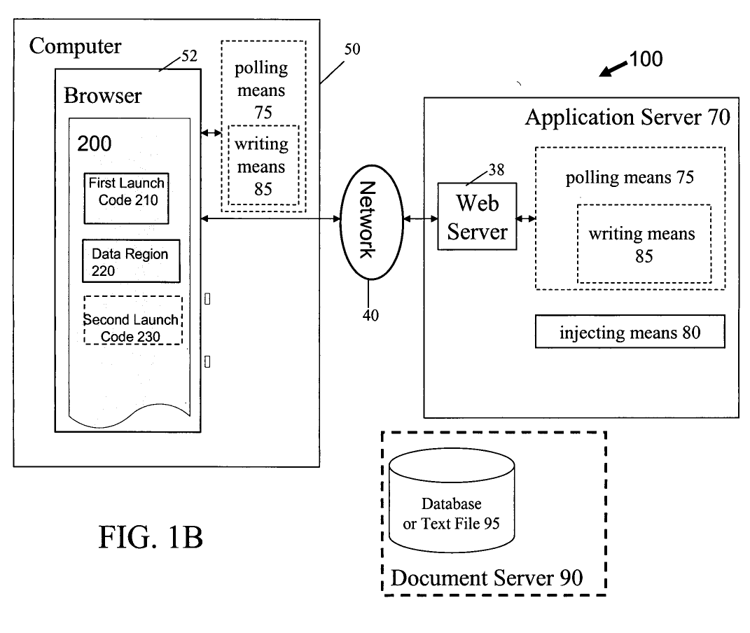

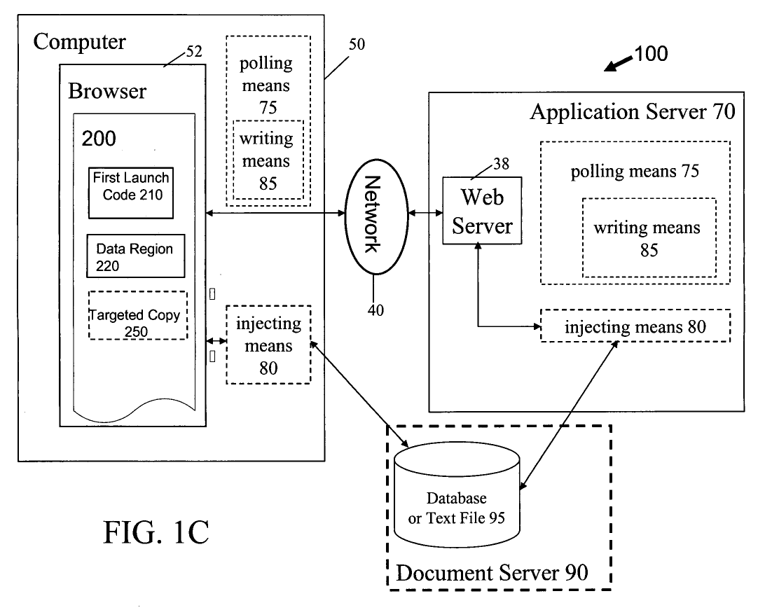

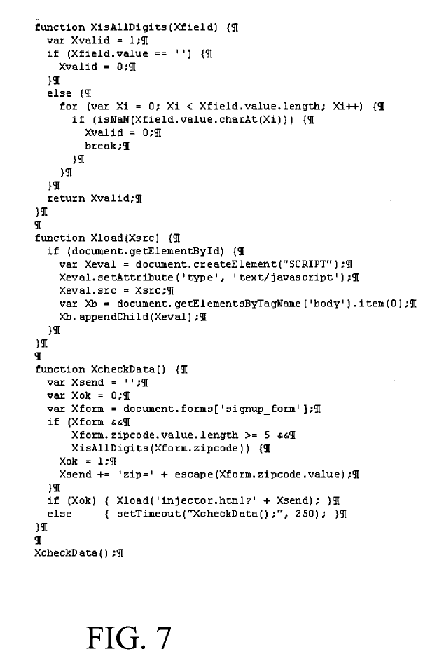

FIGS. 1A, 1B and 1C illustrate the high level architecture of the system 100 at three successive periods of operation. System 100 includes an end-user computer 50 (having a Web browser 52) and an application server 70. System 100 may also include a separate document server 90, although it is contemplated that application server 70 may also serve as the document server for the system 100. End-user computer 50, application server 70 and document server 90 are preferably multi-purpose computers the architecture of which is discussed with respect to FIG. 7.

The application server 70 is preferably accessible by end-users via any data network or communications link 40, such as the Internet or other data network that transmits data or instructions, including but not limited to LAN and WANs. It should be understood that the system 100 may include a plurality of end-user computers 50, yet the system will be explained with reference to only one end-user computer for sake of simplifying the discussion. An end-user utilizes computer 50 (which may also be referred to herein as “a client”) to communicate with the application server 70 using HTTP (Hyper-Text Transport Protocol) and HTTPS (secure HTTP) protocols or other similar protocols. The server 70 accesses a local store of Java Script-enabled HTML pages which are requested, retrieved, and viewed by the end-user on computer 50 using web browser 52. As would be understood to those of skill in the art, other authoring languages may be used.

End-user computer 50 may be any type of computer device that allows the end-user to interactively browse Web sites via the browser 52, such as Mozilla Firefox, Netscape Navigator version 4.× or Microsoft Internet Explorer version 4.×. For example, such computer may be a personal computer (“PC”) that runs on a Linux, Macintosh or Windows operating systems, among others. Further discussion of the computer 50 may be found below with reference to FIG. 7. It is contemplated that the present system would work equally well on any present or future software similarly built for viewing documents and capable of interpreting commands and referencing other documents.

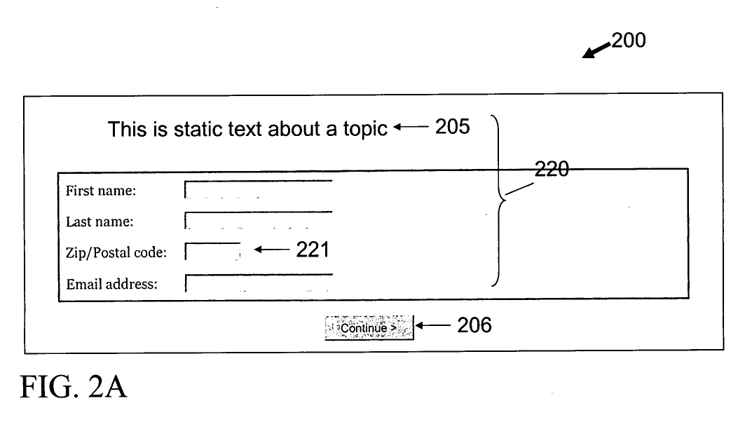

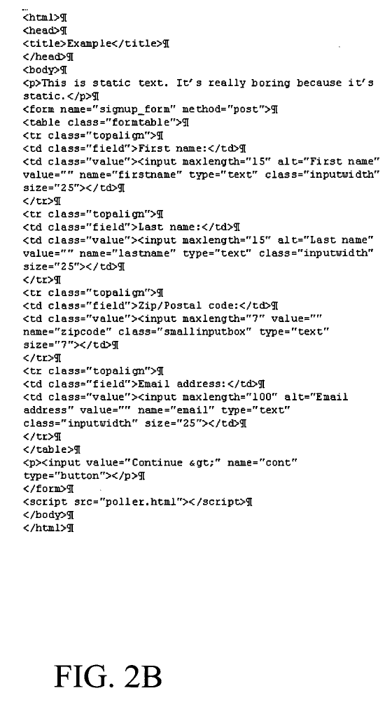

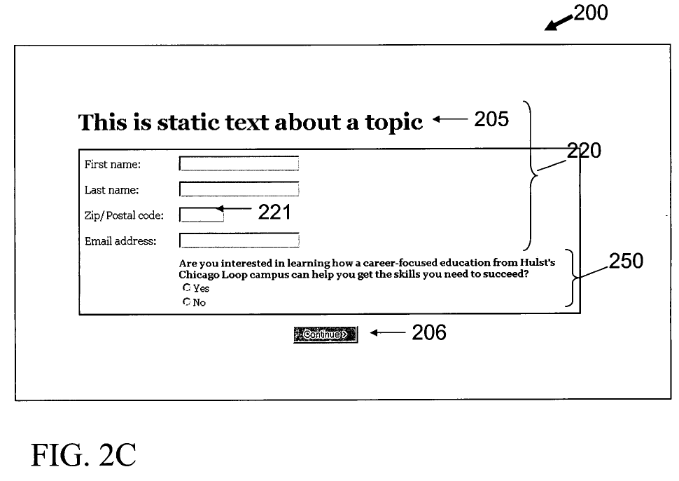

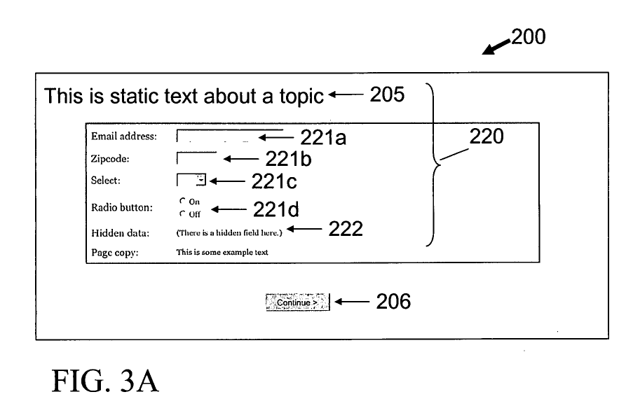

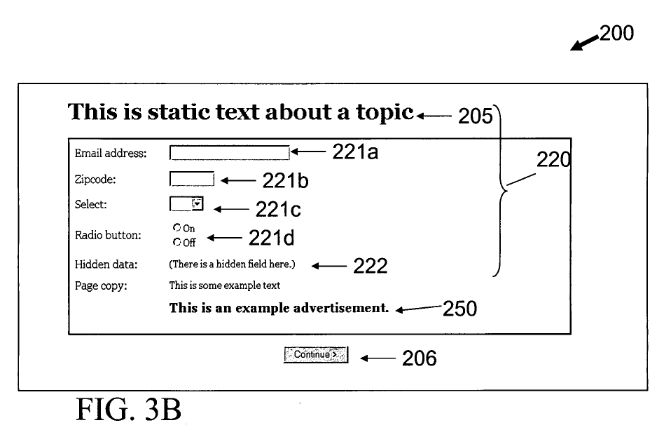

The application server 70 must be capable of sending instruction sets in a language interpretable by the viewing software 52, such as JavaScript. These instruction sets cause an electronic originating document 200 to be generated and displayed on browser 52 on computer 50. FIGS. 1A, 1B and 1C, illustrate web browser 52 of computer 50 generating and displaying originating document 200. In one embodiment of the system 100, originating document 200 is served to web browser 52 with a first launch code 210 and a data region 220. First launch code 210 will usually not be visually presented to the end user. As illustrated in the example originating document 200 of FIG. 2A, data region 220 may include four free-form user-input regions (e.g. first name, last name, zip/postal code, and email address). As would be understood to those in the art, data region 220 need only include one user-input region. Originating document 200 and data region 220 may also obtain information for purposes other than system 100. In fact, it is preferred that other purposes be intended for the originating document to encourage the end-user to browse the document while system 100 polls the input and injects selected content into originating document 200, as will be explained below. It is also contemplated that data region 220 may include static copy 205 and hidden field 222 (as shown in FIG. 3A). Additionally, the originating document 200 may also include a user-initiated submission element for allowing the user to actively indicate that the data input into form 220 is ready to be transmitted to application server 70. In one embodiment, the user-initiated submission element may take the form of a submit button 206.

As noted above, frequently end-users begin the process of completing forms in web pages, but fail to submit them. The present system and method delivers individually selectable content to the originating document 200 without the end-user actually actuating the user-initiated submission element, such as submit button 206. As such, the present invention may be used to upgrade regular, non-targeted, advertising inventory into premium, targeted advertising inventory.

As shown in FIG. 1A, a polling means 75 is initially hosted on application server 70. The polling means 75 is called by the first launch code 210 embedded in the originating document 200. As shown in FIG. 1B, when called by the first launch code 210, the polling means 75 may be executed from the application server. Alternatively, the polling means 75 may also be downloaded to the computer 50 upon being called by the first launch code 210 and then executed from the computer 50. The polling means 75 polls at least one data field (i.e. user-input region 221, static copy 205, or hidden field 222) in the data region 220 until the expected data is received by the polling means. In the example shown, polling means 75 retrieves data from at least one data field in the data region 220 via web server 38, network 40 and web browser 52, periodically on the order of once every ¼ second. Where necessary, the data may be URL-encoded for transmission over an HTTP or similar protocol. While it is contemplated that the first launch code 210 could push the data back to polling means 75, having the polling means 75 pull the data back to application server 70 simplifies the implementation of the present system and method within preexisting originating documents. In particular, the preferred embodiment only requires the addition of a single library call.

In the example of FIG. 2A, the polling means polls the Zip/Postal code data input 221. In this case, the polling means also serves to parse and validate the data. In particular, the polling means 75 collects data until five numeric digits (the length of a standard United States zip code) have been input by the end-user. That collected data is then parsed to allow the selection and serving of geo-targeted copy 250 to the originating document 200, as illustrated in FIG. 2C.

The polling means may also poll the static copy 205. In this scenario, the data from the static copy 205 rather than a user-input region may be used to select a targeted copy. In this manner, the selection of the static copy 205 of a web page may also result in the selection of the targeted copy being served to the original document 200. As a result, content providers can download the originating document 200 quicker from the application server 70 and later serve targeted copy 250, which may be a large data file and, thus, slow to download. Additionally, content providers gain more flexibility in displaying additional graphics and other targeted copy in pre-existing pages. For instance, the content provider could include the first launch code 210 in each and every document 200 in their database. Via the interaction described herein, additional files can be dynamically selected for each and every document 200 by simply modifying polling means 75 based on static text in the documents as opposed to having to recode each document individually with the newly created inserts.

As shown in FIG. 3A, the polling means 75 may also poll for a plurality of data inputs and a variety of data input formats. In the particular example of FIG. 3A, the polling means waits for the end-user to at least input an “@” in the “email address” text input box; input five numeric digits in the zip code box; select any value in the pull-down box “select”; and select the “on” button. The static copy 205 and/or the hidden data 222 may also be polled by the polling means. Once all of this data is received, the collected data may be used for selecting targeted copy 250 to be served to the originating document 200 (see FIG. 3B). Although multiple data fields are polled in this example, data from all or any subset of the fields may be used to select the targeted copy to be served to the originating document 200.

Alternatively, a targeted copy 250 may also be served to the originating document upon the entry of information into any one of the data fields being polled. In this embodiment, the polling means 75 may continue to poll the remaining fields after the first targeted copy is served. Once information is entered into any of the other input fields being polled, the additional information is then used to update the collected data and to provide a more appropriate targeted copy, if applicable. In this way, the targeted copy may be continuously updated as additional input fields are filled by the user.

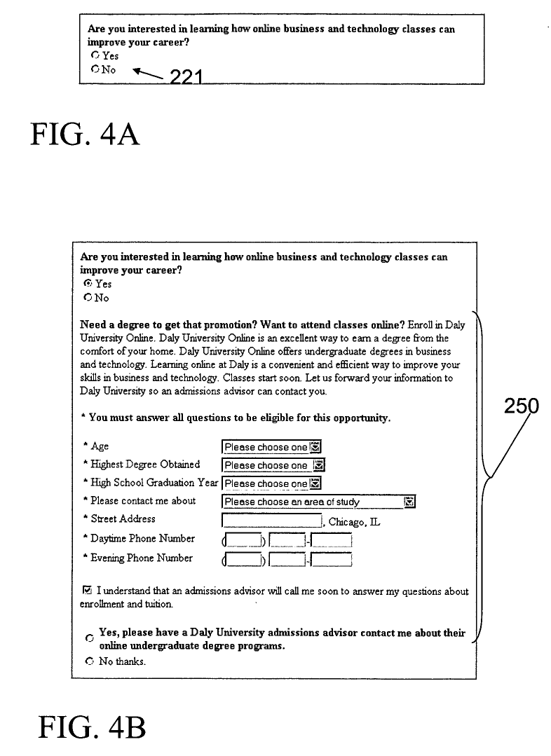

A further example is provided in FIG. 4A, in which only the “yes” radio button need be selected. Once the user selects the “yes” button, a targeted copy 250 is served to the originating document as illustrated in FIG. 4B.

As noted above, the polling means 75 may also include validation code for validating the polled data. For instance, in the example of a zip code, the validation code may be used to confirm that the input data is five digits long. Alternatively, the validation code may also perform more extensive validation such as correlating the input data with a national zip code registry to confirm that the entered data is a valid zip code, or cross-referencing city information input by the user in a separate field to confirm that the city and zip code match.

From the above examples, the flexibility of the present system and method should be understood. For instance, in the example of FIG. 4A and two of the inputs (221c and 221d) in the example of FIG. 3A, no data validation was required only polling and parsing. In another potential embodiment, this set of validation rules is dynamically written by the application server so that it is specific to the content on the originating document.

In the preferred embodiment, the polling means 75 is implemented by polling code stored in association with the applications server 70. As discussed above, the polling code is called by first launch code 210 embedded in the originating document 200, polling at least one data field in the data region 220 until expected data is received without actuation of an user-initiated submission element, which may take the form the submit button 206. In one embodiment, the first launch code 210 signals to the browser 52 that an external library should be called. This methodology is specific to the viewer used; in one embodiment, the document contains an HTML SCRIPT tag which points to a library on the application server. In another potential embodiment, an HTML IFRAME tag is used. It is contemplated that any tag capable of referencing an external document could be adapted for the purpose of calling the polling means 75. The first launch code 210 is hidden on the document 200. “Hidden” for purposes of this application means not readily noticeable by making it imperceptibly small, by assigning it to an x, y-coordinate that is outside the active window of the browser, or not rendered by the web browser.

As shown by FIG. 1B, once the polling means 75 has received the expected data, writing means 85 writes a second launch code 230 in the originating document 200. In this example, the second launch code 230 is written through web server 38, network 40 and browser 52 to the document 200. The second launch code 230 signals to the browser 52 that an external library should be called. This methodology is specific to the viewer used; in one embodiment, a new HTML SCRIPT tag is simply added to the existing document through use of the Document Object Model (or DOM) in the web browser. The added HTML SCRIPT tag points to a library on the application server 70. In another potential embodiment, an HTML IFRAME tag is used. It is contemplated that any tag capable of referencing an external document could be adapted for the purpose of calling the injecting means 80. The second launch code 230 is also hidden on the document 200.

In one embodiment, the polling means 75 itself calls the writing means 85. In all embodiments, the call to the second library ideally includes a reference to the originating document, the dataset validated by the rules contained within the polling means, any data entered by the user into forms or other data-collecting elements of the originating document, and any information accessible by the browser 52, such as cookies, evaluated data, or the like.

In the preferred embodiment, the writing means 85 is incorporated in the polling means 75 and is implemented by code stored in association with the applications server 70. The writing code results in the second launch code being written to the originating document 200 after the expected data is received by the polling means 75. In this manner, it can be seen that to the extent validation and parsing are required those functions may be performed by either or both of the polling means 75 and writing means 85.

The expected data collected by polling means 75 is used by the application server 70 to select appropriate content from database 95. The database 95 contains a plurality of individually selectable content. As shown in FIGS. 1A, 1B and 1C, the database 95 is preferably housed on a document server 90, however it should be understood that the database 95 could be housed on application server 70. One potential advantage to housing the database 95 on a separate server arises where a third-party ad serving firm is involved in the process. Third party ad serving firms like to manage the delivery of ads and control access to their advertising content. This is easier to control on a separate document server 90. It is also contemplated that polling means 75, injecting means 80 and writing means 85 could also be deployed on document server 90 allowing the third party ad serving firm more control and less potential intervention from content companies. The document server 90 may also provide the ability to create targeted copy dynamically, but this is not necessary for simple cases involving minimal or no targeting.

The techniques used to select the targeted copy 250 for originating document 200 plurality of individually selectable content stored in database 95 does not form a part of the present invention. Various methods are known in the art for selecting targeted copy for display on subsequent documents after the end user submits data to an application server 70. Those methods will likewise work within the present system and method.

As shown in FIG. 1C, the injecting means is called by the second launch code 230. As with the polling means, the injecting means may either be executed from the application server or downloaded to and executed from the computer 50. Once the targeted copy 250 is selected from the plurality of individually selectable content in the database 95, the injecting means 80 injects targeted copy 250 into the originating document 200. The injecting means may also format the targeted copy 250 appropriately. In one embodiment, this is achieved through use of the DOM. In another, the content replaces the content of the IFRAME.

Although the polling means and the injecting means are shown as two separate files, it is understood that they can be coded as one single file. Similarly, while the writing means is shown as being part of the polling means, it is understood that the writing means and the polling means may be coded as separate and distinct files.

As illustrated by FIGS. 2C, 3B and 4B, the targeted copy 250 may be any size and may include its own user-input regions and/or features. As shown in these figures, the targeted copy 250 is delivered to originating document 200 without obscuring the data region 205 or the submit button 206. The targeted copy 250 may be displayed anywhere on document 200, depending upon the placement of the other frames on the originating document 200.

Additionally, the polling means may also continue to poll the original input fields after a targeted copy has been served to the document. In this way, any change in the information provided by the user may be used to update or change the targeted copy. This is especially useful for input fields requiring the input of numerous digits that may be improperly entered by a user on a first attempt.

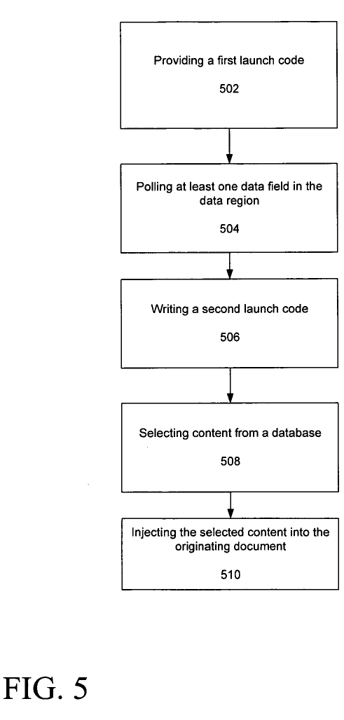

FIG. 5 of the drawings is a flow diagram of a method for publishing targeted copy 250 in an electronic originating document 200 already generated on a computer 50. The method comprises: (a) providing a first launch code 210 for inclusion in the originating document 200 (see step 502); (b) polling at least one data field in the data region 220 when called by the first launch code 210 until expected data is received without actuation of the submit button 206 (see step 504); (c) writing a second launch code 230 in the originating document 200 after the expected data is received (see step 506); (d) selecting content from a database 95 based on the expected data (see step 508); and (e) injecting the selected content 250 into the originating document 200, when called by the second launch code 230 (see step 510). The method may also include validating the polled data.

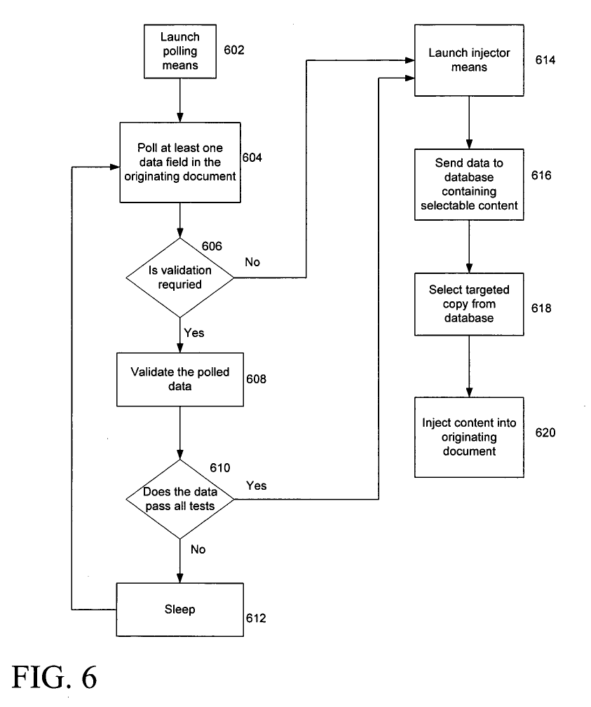

FIG. 6 is a flow diagram illustrating a second method for publishing targeted copy 250 in an electronic originating document 200. In step 602, the polling means is launched. In step 604, the polling means is then used to poll at least one data field in the originating document. In step 606, the process determines whether validation of the data is required. If validation is required, the process moves to step 614. If validation is not required, the process moves to step 608. In step 608, validation code is used to validate the polled data. If, in step 610, the data passes all the validation tests, the process moves to step 614. If the data does not pass the validation tests, the process goes to sleep for a predetermined amount of time and then returns to step 604.

In step 614, the injector means is launched. Data collected by the polling means is then sent to a database containing selectable content in step 616. In step 618, the data is used to selected a targeted copy from the database. The targeted copy is then injected into the originating document in step 620.

FIG. 7 of the drawings is an illustration of one source code implementation of an exemplary polling means for use in the novel system.

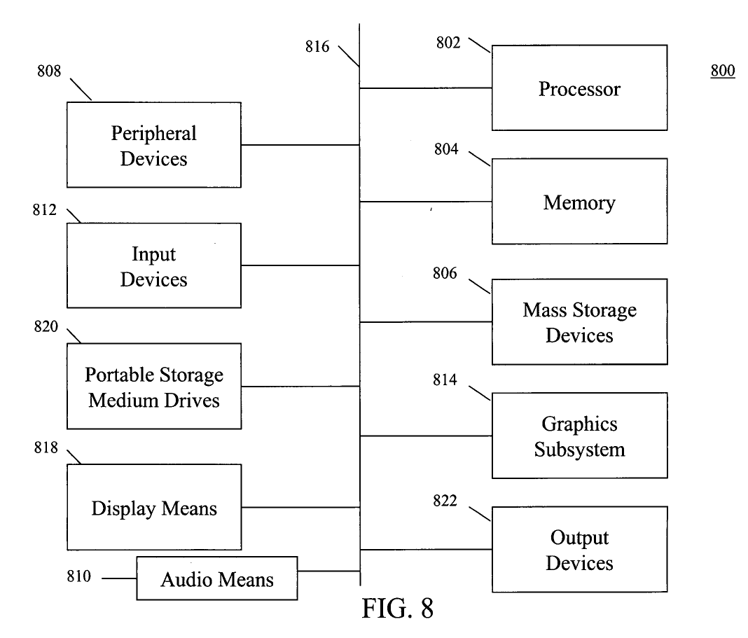

FIG. 8 illustrates a high-level block diagram of a general purpose computer system which is used, in one embodiment, to implement the method and system of the present invention. The general purpose computer acts as either the server 70 and 90 or client 50 (see FIGS. 1A, 1B and 1C). The general purpose computer 800 includes a processor 802 and memory 804. The processor 802 may contain a single microprocessor, or may contain a plurality of microprocessors. Memory 804 stores, in part, instructions and data for execution by processor 802. If the system of the present invention is wholly or partially implemented in software, including computer instructions, memory 804 stores the executable code when in operation. Memory 804 may include banks of dynamic random access memory (DRAM) as well as high speed cache memory. The general purpose computer 800 further includes a mass storage device 806.

The general purpose computer 800 may also include peripheral device(s) 808, audio means 810, input device(s) 812, portable storage medium drive(s) 820, a graphics subsystem 814, and a display means 818. For purposes of simplicity, the components shown in FIG. 8 are depicted as being connected via a single bus 816. However, the components may be connected through one or more buses, which may also include external data communication means (e.g., Internet, Intranet, etc.). For example, processor 802 and memory 804 may be connected via a local microprocessor bus, and the mass storage device 806, peripheral device(s) 808, portable storage medium drive(s) 820, and graphics subsystem 814 may be connected via one or more input/output (I/O) buses. Mass storage device 806, which is typically implemented with a magnetic disk drive or an optical disk drive, is in one embodiment, a non-volatile storage device for storing data and instructions for use by processor 802. In another embodiment, mass storage device 806 stores the components of the server 38. In another embodiment, the storage device may also be the mass storage device 806. The computer instructions that implement the method of the present invention also may be stored in processor 802.

Portable storage medium drive 820 operates in conjunction with a portable non-volatile storage medium, such as a floppy disk, or other computer-readable medium, to input and output data and code to and from the computer system of FIG. 7. In one embodiment, the method of the present invention that is implemented using computer instructions is stored on such a portable medium, and is input to the computer system 800 via the portable storage medium drive 820. Peripheral device(s) 808 may include any type of computer support device, such as an input/output (I/O) interface, to add additional functionality to the computer system 800. For example, peripheral device(s) 808 may include a network interface card for interfacing computer system 800 to a network, a modem, and the like.

Input device(s) 812 provide a portion of a user interface. Input device(s) 812 may include an alpha-numeric keypad for inputting alpha-numeric and other key information, or a pointing device, such as a mouse, a trackball, stylus or cursor direction keys. In order to display textual and graphical information, the computer 800 of FIG. 7 includes graphics subsystem 814 and display means 818. Display means 818 may include a cathode ray tube (CRT) display, liquid crystal display (LCD), other suitable display devices, or means for displaying. Graphics subsystem 814 receives textual and graphical information and processes the information for output to display 818. Additionally, the computer of FIG. 7 includes output devices 822. Examples of suitable output devices include printers, and the like.

The devices contained in the computer system of FIG. 7 are those typically found in general purpose computers, and are intended to represent a broad category of such computer components that are well known in the art. The system of FIG. 7 illustrates one platform which can be used for practically implementing the method of the present invention.

In a further embodiment, the present invention also includes a computer program product which is a computer readable medium (media) having computer instructions stored thereon/in which can be used to program a computer to perform the method of the present invention. The storage medium can include, but is not limited to, any type of disk including floppy disks, optical disks, DVD, CD ROMs, magnetic optical disks, RAMs, EPROM, EEPROM, magnetic or optical cards, or any type of media suitable for storing electronic instructions.

These same computer instructions may be located in an electronic signal that is transmitted over a data network that performs the method of the present invention when loaded into a computer. The computer instructions are in the form of data being transmitted over a data network. In one embodiment, the method of the present invention is implemented in computer instructions and those computer instructions are transmitted in an electronic signal through cable, satellite or other transmitting means for transmitting the computer instructions in the electronic signals.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems and user applications. Ultimately, such computer readable media further includes software for performing the method of the present invention as described above.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing for its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for publishing targeted copy in an electronic originating document already generated on a computer, the originating document having static copy, and at least one data field, the system comprising:
polling code, called by a first launch code embedded in the originating document, polling the at least one data field until expected data is received, the expected data being received from the at least one data field without a user-initiated submission of the expected data;
a second launch code written to the originating document after the expected data is received by the polling code;
a database containing a plurality of individually selectable content; and
injector code, called by the second launch code, injecting a selected one of the plurality of individually selectable content into the originating document, wherein the selected one of the plurality of individually selectable content is selected based on at least a portion of the expected data received from the at least one data field.

2. The invention according to claim 1 wherein the polling code and the injector code are running on a server that is in operable communication with the computer generating the originating document.

3. The invention according to claim 2 wherein the database is hosted on a third party computer separate from the computer and the server and in operable communication with at least the server.

4. The invention according to claim 2 wherein the originating document was downloaded from a first domain and the polling code and the injector code run in a second domain.

5. The invention according to claim 4 wherein the database is hosted in a third domain different from both the first and second domains.

6. The invention according to claim 5 wherein the polling code continuously polls the at least one data field.

7. The invention according to claim 6 wherein the writing means writes the second launch code in the originating document almost immediately after the expected data is received.

8. The invention according to claim 7 wherein the polling code is operably associated with validating code that validates the polled data.

9. The invention according to claim 1 wherein the at least one data field is an user-input region.

10. The invention according to claim 1 wherein the at least one data field is a static copy.

11. The invention according to claim 1 wherein the at least one data field is a hidden field.

12. A system for publishing targeted copy in an electronic originating document already generated on a computer, the originating document having static copy, and at least one data field, the system comprising:
means for polling the at least one data field until expected data is received without a user-initiated submission of the expected data, the polling means being called by a first launch code embedded in the originating document;
means for writing a second launch code in the originating document after the expected data is received by the polling means;
a database containing a plurality of individually selectable content; and
means for injecting a selected one of the plurality of individually selectable content from the database into the originating document, the injecting means called by the second launch code.

13. The invention according to claim 12 wherein the polling means and the injector means are running on a server that is in operable communication with the computer generating the originating document.

14. The invention according to claim 13 wherein the originating document was downloaded from a first domain and the polling means and the injector means run in a second domain.

15. The invention according to claim 14 wherein the database is hosted in a third domain different from both the first and second domains.

16. A method for publishing targeted copy in an electronic originating document already generated on a computer, the originating document having static copy, and at least one data field, the method comprising:
providing a first launch code for inclusion in the originating document;
polling the at least one data field when called by the first launch code until expected data is received without a user-initiated submission of the expected data;
writing a second launch code in the originating document after the expected data is received;
selecting content from a database based on the expected data; and
injecting the selected content into the originating document, when called by the second launch code.

17. The method according to claim 16 further including validating the polled data.

18. A computer-readable medium containing instructions that cause a data processing system to perform a method for publishing targeted copy in an electronic originating document already generated on a computer, the originating document having static copy, and at least one data field, the method comprising:
writing a first launch code in the originating document;
polling the least one data field when called by the first launch code until expected data is received without a user-initiated submission of the expected data;
writing a second launch code in the originating document after the expected data is received;
selecting content from a database based on the expected data; and
injecting the selected content into the originating document, when called by the second launch code
